(19) United States
(12) Patent Application Publication
(10) Pub. No.: US 2011/0016772 A1
(43) Pub. Date: Jan. 27, 2011

(54) Acid Esterification Through Nano Reactor

(76) Inventor: Mahesh Talwar, Somis, CA (US)

Correspondence Address: AVERILL & GREEN, 8244 PAINTER AVE., WHITTIER, CA, 90602, US

(21) Appl. No.: 12/509,346

(22) Filed: Jul. 24, 2009

(51) Int. Cl. C10L 1/18; B01J 19/00

(52) U.S. Cl. 44/307; 44/639

(57) ABSTRACT

A biodiesel generation system incorporates acid esterification through a hydro-cavitation based nano reactor. A feed material is a mixture of approximately 30 percent Palm Fatty Acid Distillate (PFAD) mixed with Para Toluene Sulfonic Acid (PTSA) as an acid catalyst and methanol as a reagent. The PFAD is approximately 90 percent Free Fatty Acid (FFA) resulting in the feed material being approximately 27 percent FFA. The acid catalyst in the feed material facilitates an esterification process to produce biodiesel. The feed material is pumped through the hydro-cavitation based nano reactor and forced through a nano orifice where, by a phenomenon of hydro cavitation, collapsing nano liquid molecules can generate instantaneous temperatures of 1000 degrees centigrade resulting in quick reaction taking place at the surface of collapsing nano molecules. Partially reacted feed material may be recycled through the nano reactor several times to complete the reaction.

### BACKGROUND OF THE INVENTION

The present invention relates to biodiesel production and in particular to acid esterification of Palm Fatty Acid Distillate (PFAD) to produce biodiesel.

Recent increases in the cost of petroleum have raised both economic and national security concerns. Petroleum costs translate directly into gasoline and diesel fuel costs which impact both personal and commercial expenses. Various alternatives for powering vehicles have been proposed and in various stages of maturity. These alternatives including: natural gas; electricity; hydrogen; and biodiesel. Biodiesel is an alternative fuel for conventional diesel engines and offers advantages including less pollution, but presently is not available in large quantities.

Biodiesel is produced from ingredients comprising feed oils (vegetable oils or animal fats), a small percentage of alcohol, and a catalyst. The process for producing biodiesel fuel, commonly called transesterification, generally includes a tradeoff between reaction time and temperature, and involves the reaction of triglycerides in the feed oils with the alcohol to produce a mixture of methyl esters and glycerin. The production of biodiesel fuel in the US reached approximately 250 million gallons in 2006 compared to diesel fuel consumption of over 50 billion gallons a year in the US.

Conventional biodiesel production technology involves introducing the feed oil, methanol, and a catalyst into a two stage reactor vessel and requires up to two hours or more for completion of a chemical reaction converting the ingredients into biodiesel fuel and a glycerine byproduct. Many plants have incorporated multiple reactor systems to do continuous batch processing. High residence time in reactors requires very large reactor vessels, for example, a 20 gallon per minute (10 million gallons/year) plant will require total reactor vessel capacity of about 3,600 gallons which requires a large foot print. Additionally, high residence time promotes a secondary formation of soaps which are undesired contaminants and must be removed using an expensive wash technology to meet biodiesel fuel specifications. Soaps also trap product biodiesel with resulting yield loss of two to three percent. Soaps in the glycerine byproduct also make the glycerine less desirable because it requires acidulation and results in production of acid oils which have very low market value and often require disposal as a hazardous liquid waste.

IKA Corporation sells high shear reactors intended to address the time/heat issues of biodiesel fuel production. Reaction inside each high shear reactor is fast, only a few seconds; however, the IKA process requires two stage high shear pumps with intermediate holding tanks to complete the reaction. Holding tanks complete the reaction in about 15-20 minutes, and soap formation is not eliminated.

Arisdyne Systems and Hydro Dynamics, Inc. make hydrodynamic cavitations based reactors intended to address the time/heat issues of biodiesel production. While these reactors speed up the reaction, each facility requires a complex two stage reactor system to complete the reaction which increases complexity of the system and costs involved.

U.S. patent application Ser. No. 12/262,942 for “Apparatus and Method for Rapid Biodiesel Fuel Production” filed 31 Oct., 2008 by the present applicant disclosed apparatus and method for rapid production of biodiesel fuel. The apparatus includes a packed column followed by a high pressure kinetic reactor. A homogeneous stream of feed oil (vegetable oil or animal fat), methanol, and a catalyst is metered, mixed, fed into a packed column, and finally into the high pressure kinetic reactor where the conversion into biodiesel fuel is completed. The packed column is packed with rings (either Raschig rings or pall rings or equivalent). The homogeneous stream enters from the bottom with rings kept in a fluidized bed state to allow greatest surface area for reaction to take place. Approximately 40 to 70 percent reaction is typically achieved in the packed column. The high pressure kinetic reactor receives the partially reacted homogeneous stream and breaks fluid molecules into nano molecules with very high instantaneous temperatures and availability of large surface areas which allow complete reaction without external heat. The system of the '942 patent works well for feed material with less than five percent Free Fatty Acid (FFA) utilizing base catalyst for trans esterification reaction to produce biodiesel, but does not perform well for higher percentages of FFA.

Thus, a need remains for an esterification system effective for greater then five percent FFA.

### BRIEF SUMMARY OF THE INVENTION

The present invention addresses the above and other needs by providing a biodiesel generation system incorporating acid esterification through a hydro-cavitation based nano reactor which processes feed material having more than five percent Free Fatty Acid (FFA). A feed material is a mixture of approximately 30 percent by weight Palm Fatty Acid Distillate (PFAD) mixed with Para Toluene Sulfonic Acid (PTSA) as an acid catalyst and methanol as a reagent. The PFAD is approximately 90 percent by weight FFA resulting in a feed material having approximately 27 percent by weight FFA. The acid catalyst in the feed material facilitates an esterification process to produce biodiesel. The PFAD, PTSA, and methanol are mixed and pumped through the hydro-cavitation based nano reactor and forced through a nano orifice where by a phenomenon of hydro cavitation, collapsing nano liquid molecules can generate instantaneous temperatures of 1000 deg C. resulting in quick reaction taking place at the surface of collapsing nano molecules. The partially reacted PFAD, PTSA, and methanol may be recycled through the nano reactor several times to complete the reaction utilizing a novel multi loop biodiesel generation system.

In accordance with one aspect of the invention, there is provided a method for producing biodiesel using acid esterification. The method includes mixing a feed oil, acid catalyst, and solvent mixture in a nano reactor feed tank, heating the feed oil, acid catalyst, and solvent mixture to produce a partially reacted feed oil, acid catalyst, and solvent mixture, pumping the partially reacted feed oil, acid catalyst, and solvent mixture through a cavitation chamber to continue the reaction, cycling the partially reacted feed oil, acid catalyst, and solvent mixture through the cavitation chamber more than one time to continue the reaction to produce raw biodiesel and distilling the raw biodiesel to produce finished biodiesel. The feed oil is preferably Palm Fatty Acid Distillate (PFAD) and the acid solvent is preferably Para Toluene Sulfonic Acid (PTSA). Methanol is added as a solvent. The feed oil, acid catalyst, and solvent mixture is heated to approximately 80 degrees centigrade to start the reaction and the cavitation chamber includes a nano orifice whereby a phenomenon of hydro cavitation, collapsing nano liquid molecules generates instantaneous temperatures of up to 1,000 degrees centigrade resulting in quick reaction taking place at the surface of the collapsing nano liquid molecules to continue the reaction.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an acid esterification system according to the present invention.

FIG. 2 is a raw biodiesel processor according to the present invention.

FIG. 3 is a cavitation chamber according to the present invention.

FIG. 4 is a cavitation chamber nozzle according to the present invention.

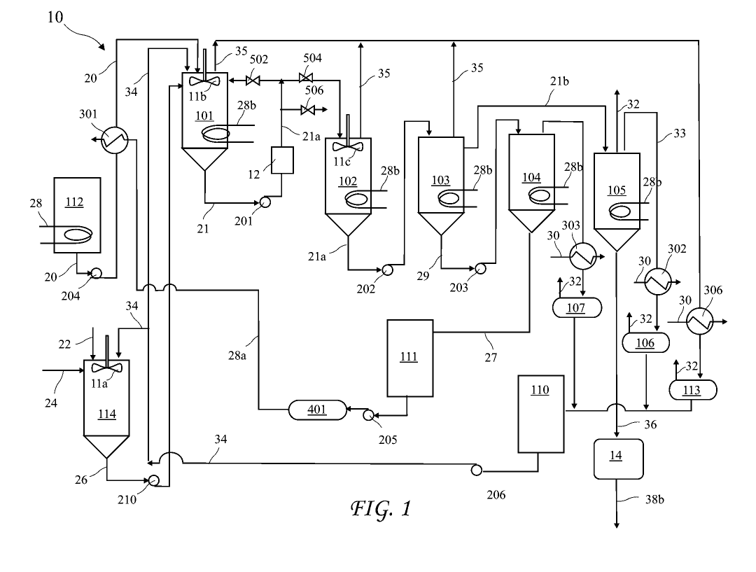

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The present invention is a Palm Fatty Acid Distillate (PFAD) derived biodiesel made from the acid catalysis using Para Toluene Sulfonic Acid (PTSA) as a catalyst, and methanol as a reagent, through a hydro-cavitation based nano reactor 12 utilizing a unique multi loop system allowing precessing of feed material having greater than five percent fatty acid.

A mixture of PTSA in powder form 22, recovered methanol 34, and fresh makeup methanol 24 is introduced into a PTSA tank 114 and stirred by a first agitator 11a to prepare an acid catalyst 26. The acid catalyst 26 is preferably approximately 30 percent by weight PTSA and approximately 70 percent by weight methanol. The acid catalyst 26 is pumped by pump 210 into nano reactor feed tank 101. PFAD 20 contained in PFAD tank 112 is pumped by pump 204 through a heat exchanger 301 into the nano reactor feed tank 101. The PFAD is heated by flowing through heat exchanger 301 using steam 28a generated from recovered water 27. Additional recovered methanol 34 is also pumped into the nano reactor feed tank 101. The PFAD, PTSA, and methanol if mixed in the nano reactor feed tank 101 by a second agitator 11b. The total methanol is regulated to not exceed 40 percent by weight of the incoming PFAD. A PFAD and catalyst mixture 21 in the cavitation chamber feed tank 101 is heated to approximately 80 degrees centigrade reaction temperature by steam 28b from a boiler (not shown). The reaction of the PFAD and catalyst to produce biodiesel starts when the PFAD and catalyst mix in the feed tank 101.

The mixture 21 is then pumped by a reactor pump 201 into a cavitation chamber (or nano reactor) 12 which continues the reaction through hydro cavitation. In the cavitation chamber 12, the fluid is forced through a nano orifice where, by a phenomenon of hydro cavitation, collapsing nano liquid molecules can generate instantaneous temperatures of 1,000 degrees centigrade resulting in quick reaction taking place at the surface of collapsing nano molecules to produce a reacted mixture 21a. The PTSA is a very strong acid catalyst resulting in quick reaction.

The biodiesel reaction is performed by cycling the PFAD and catalyst mixture 21 through the cavitation chamber 12 several times. During the biodiesel reaction, a cycling valve 502 is open and a release valve 504 is closed. Thus, the partially (or potentially fully) reacted PFAD and catalyst mixture 21 is re-circulated back to the cavitation chamber feed tank 101 for a period of time T1 to complete the reaction with additional reaction taking place at each pass. The time T1 is preferably between three minutes and five minutes and more preferably approximately three minutes and the PFAD and catalyst mixture 21 is cycled through the cavitation chamber 12 about six times.

The PFAD is mostly Free Fatty Acid (FFA) with very little tri gicyerides. All of the FFA is converted to biodiesel through the nano esterification process (through the cycling through the cavitation chamber 12). The minute quantity of tri glyceride goes through acid trans-esterification process due to PTSA being a strong catalyst. Excess catalyst dosing of approximately five percent by weight of the incoming PFAD is provided to complete the trans-esterification process of the tri glyceride into biodiesel.

After T1 minutes of reaction are completed, the valve 502 is closed and the valve 504 is opened and the reacted mixture 21a is sent to a surge tank 102 and stirred by a third agitator 11c. From the surge tank 102, the reacted mixture 21a is pumped by a surge tank pump 202 to a settling tank 103. The reacted mixture 21a phase separates with recovered methanol 35 rising to the top of the settling tank 103, a methanol and water mixture 29 phase settling to the bottom of the settling tank 103, and settled biodiesel 21b in the center. The water component of the methanol and water mixture 29 is a byproduct of the trans-esterification process.

The methanol and water mixture 29 is pumped to a first demethylation tank 104 and demethylated. The methanol and water mixture 29 is stripped of methanol in the first demethylation tank 104 and the recovered water 27 is sent to recovered water tank 111. The recovered water 27 is then sent to a boiler 40 through boiler pump 205 where the recovered water 27 is converted to process steam 28a used to heat the incoming PFAD 20. The condensed water is either stored for process use or discharged as clean pure water.

The settled biodiesel 21b flows, preferably by gravity, to a second demethylation tank 105 where the settled biodiesel 21b is heated to 80 degrees centigrade under a vacuum 32. Methanol remaining in the settled biodiesel 21b is boiled off as methanol vapor 33 and condensed in cold water 30 heat exchanger 302 and sent to receiver tank T-6. Methanol vapor 33 formed in tank 104 is condensed in cold water 30 heat exchanger 503 and sent to receiver tank 107. Methanol vapor 33 collected from tanks 101, 102, and 103 is sent through cold water 30 heat exchanger 306 to receiver tank 113. A vacuum 32 is drawn from tanks 106, 107, and 113 and recovered methanol is stored in methanol tank 110. The recovered methanol in the tank 110 and reused pumped through pump 206 for use in tanks 101 and 114. Raw biodiesel 36 from the demethylation tank 105 is sent to a biodiesel distillation system 14 for final processing to produce the finished biodiesel 38b.

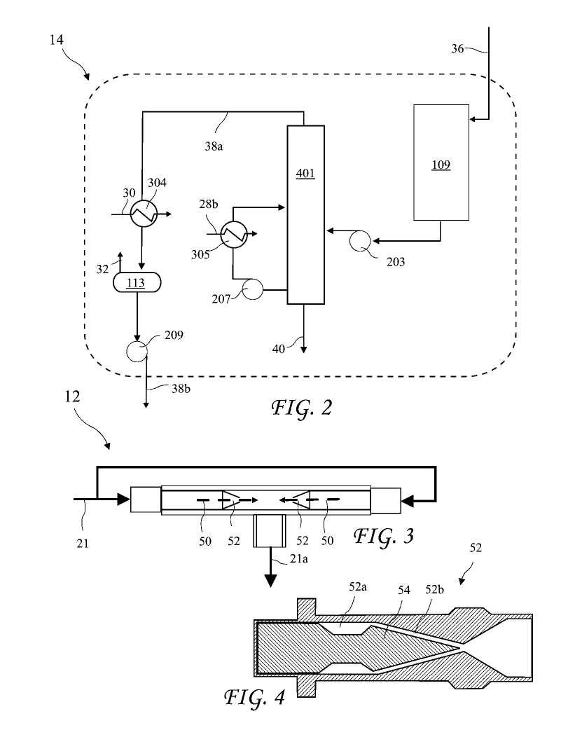

The biodiesel distillation system 14 is described in FIG. 2. The raw biodiesel 36 is sent to a surge tank 109 which feeds the raw biodiesel 36 through pump 203 to a distillation column 401. The raw biodiesel 36 is stripped of impurities at high vacuum (drawn from the receiver tank 113) and temperature provided by heat exchanger 305, and processed biodiesel vapors 38a are condensed in a cold water 30 heat exchanger 304 producing finished biodiesel 38b sent to receiver tank 108. The finished biodiesel 38b is pumped through pump 209 to a finished biodiesel storage tank (not shown).

Biodiesel in the distillation column 401 is vaporized through steam 28b heat exchanger 305 which receives the biodiesel through pump 207. Approximately 90 percent by weight of the biodiesel is vaporized and recovered through the cold water 30 heat exchanger 305, waste biodiesel 40 comprising a remaining approximately ten percent by weight of the total biodiesel is drawn at the bottom of the distillation column 401 and stored for boiler fuel for generating the steam 28b.

An example of the cavitation chamber 12 is shown in FIG. 3. The cavitation chamber 12 utilizes impingement technology whereby two streams collide with each other causing additional contact for complete reaction of the ingredients into biodiesel fuel. The high pressure kinetic reactor is operated at 900 to 1,000 PSI pressure and is composed of adjustable need valve design where fluid entering the cavitation chamber 12 is forced out through an orifice which is adjustable through internal needle valve, causing high shear and cavitation and a split orifice design in the cavitation chamber 12 where fluid is first forced through two identical split orifices 52 at each end of the cavitation chamber 12, causing high shear and cavitation and then the two streams impinge on each other from opposite direction to complete the reaction producing the biodiesel fuel. While a high pressure cavitation chamber 12 is described above, biodiesel fuel production systems including other kinetic reactors operating on the principles of hydro cavitation are intended to come within the scope of the present invention.

A cross-sectional view of the split orifice 52 is shown in FIG. 4. A flow shaping cone (or needle valve) 54 resides in the split orifice 52 and forms a nozzle cavity 52a and a conical flow accelerator (or high pressure orifice) 52b between the flow shaping cone 54 and the interior of the nozzle 52. The nozzle 52 receives the flow of PFAD and catalyst mixture 21 into the nozzle cavity 52a and the flow accelerates through the conical flow accelerator 52b and is directed against an opposing similarly formed flow to provide the hydro cavitation.

The system described herein may be operated as a zero discharge system and all vapors, water, methanol, and the like generated by biodiesel processing is recovered and used within the system.

While the invention herein disclosed has been described by means of specific embodiments and applications thereof, numerous modifications and variations could be made thereto by those skilled in the art without departing from the scope of the invention set forth in the claims.

I claim:

1. A method for producing biodiesel using acid esterification, the method comprising:
pumping Palm Fatty Acid Distillate (PFAD) through a steam heated heat exchanger into a nano reactor feed tank;
mixing Para Toluene Sulfonic Acid (PTSA) as a catalyst, and methanol as a reagent in a PTSA tank;
pumping the PTSA and methanol mixture into the nano reactor feed tank;
pumping additional methanol into the nano reactor feed tank;
mixing a PFAD, PTSA, and methanol in the nano reactor feed tank to create a PFAD, catalyst, and solvent mixture;
heating the PFAD, catalyst, and solvent mixture to produce a partially reacted PFAD, catalyst, and solvent mixture;
pumping the partially reacted PFAD, catalyst, and solvent mixture through a nano reactor including a cavitation chamber to continue the reaction;
cycling the partially reacted PFAD, catalyst, and solvent mixture through the cavitation chamber more than one time to continue the reaction to produce raw biodiesel;
collecting first gaseous methanol from the nano reactor feed tank;
pumping the raw biodiesel into a surge tank;
heating the raw biodiesel in the surge tank and drawing recovered methanol from the surge tank;
collecting additional of the first gaseous methanol from the surge tank;
pumping a first partially refined biodiesel from the surge tank to a settling tank;
heating the first partially refined biodiesel in the settling tank to produce settled biodiesel;
collecting additional of the first gaseous methanol from the settling tank;
cooling the first gaseous methanol and passing the first cooled methanol to a first recover tank under vacuum and on to a recovered methanol tank for reuse;
recovering a liquid methanol and water mixture from the settling tank;
pumping the liquid methanol and water mixture to a first demethylation tank;
heating the liquid methanol and water mixture in the demethylation tank;
separating liquid water and second gaseous methanol in the demethylation tank and releasing the water to a recover water tank;
cooling the second gaseous methanol and passing the cooled second methanol to a second recover tank under vacuum and on to a recovered methanol tank for reuse;
passing the settled biodiesel to a second demethylation tank;
heating the settled biodiesel under a vacuum to separate third gaseous methanol from the settled biodiesel to produce raw biodiesel;
cooling the third gaseous methanol and passing the cooled third methanol to a third recover tank under vacuum and on to the recovered methanol tank for reuse;
passing the raw biodiesel through a surge tank to a distillation column;
pumping the raw biodiesel through a steam heated heat exchanger and back into the distillation column;
collecting distilled biodiesel from the distillation column′
cooling the distilled biodiesel;
passing the cooled biodiesel through a receiver tank under vacuum to produce finished biodiesel.

2. The method of claim 1, wherein pumping the partially reacted PFAD, catalyst, and solvent mixture through a nano reactor including a cavitation chamber comprises forcing the partially reacted PFAD, catalyst, and solvent mixture through a nano orifice where, by a phenomenon of hydro cavitation, collapsing nano liquid molecules to generate instantaneous temperatures of approximately 1,000 degrees centigrade resulting in quick reaction taking place at the surface of collapsing nano molecules to continue the reaction of the partially reacted PFAD, catalyst, and solvent mixture.

3. A biodiesel production system comprising:
a nano reactor feed tank containing a feed oil and acid catalyst mixture wherein the feed oil includes greater than five percent by weight Free Fatty Acid (FFA);
a reactor pump in fluid communication with the nano reactor feed tank;
a cavitation chamber in fluid communication with the reactor pump for receiving the feed oil and acid catalyst mixture and producing a reacted mixture;
a return path between the cavitation chamber and the nano reactor feed tank;
a valve in the return path to open and close the return path; and
a release valve in fluid communication with the cavitation chamber for releasing the reacted mixture to complete processing of the biodiesel.

4. The system of claim 3, wherein the feed oil consists essentially of Palm Fatty Acid Distillate (PFAD).

5. The system of claim 3, wherein the feed oil is approximately 30 percent by weight of the feed oil and acid catalyst mixture.

6. The system of claim 3, wherein the acid catalyst consists essentially of Para Toluene Sulfonic Acid (PTSA).

7. The system of claim 6, wherein the PTSA is approximately 30 percent by weight of the feed oil and acid catalyst mixture.

8. The system of claim 7, wherein the feed oil and acid catalyst mixture further includes methanol as a solvent.

9. The system of claim 3, wherein cavitation chamber includes a nano orifice where, by a phenomenon of hydro cavitation, collapsing nano liquid molecules generate instantaneous temperatures of up to 1,000 degrees centigrade resulting in quick reaction taking place at the surface of the collapsing nano liquid molecules to produce the reacted mixture.

10. The system of claim 3, wherein the feed oil and acid catalyst mixture in the nano reactor feed tank is heated to approximately 80 degrees centigrade reaction temperature to start a reaction between the feed oil and catalyst to generate biodiesel.

11. The system of claim 3, wherein the feed oil and acid catalyst mixture cycles through the cavitation chamber for a period of time between three and five minutes to complete the reaction into biodiesel.

12. The system of claim 3, wherein the feed oil and acid catalyst mixture is cycles through the cavitation chamber for a period of time of approximately three to compete the reaction into biodiesel.

13. The system of claim 3, wherein the feed oil and acid catalyst mixture is cycled through the cavitation chamber approximately six times to compete the reaction into biodiesel.

14. The system of claim 3, further including a demethylation section for recovering methanol solvent for reuse.

15. The system of claim 3, further including biodiesel distillation for processing the reacted mixture to strip off impurities.

16. The system of claim 15, wherein waste biodiesel comprising a remaining approximately ten percent by weight of the total biodiesel in a distillation column is drawn at the bottom of the distillation column and stored for boiler fuel for generating steam for use in heat exchanger elements of the biodiesel production system.

17. A method for producing biodiesel using acid esterification, the method comprising:
mixing a feed oil, acid catalyst, and solvent mixture in a nano reactor feed tank;
heating the feed oil, acid catalyst, and solvent mixture to produce a partially reacted feed oil, acid catalyst, and solvent mixture;
forcing the feed oil, acid catalyst, and solvent mixture through a cavitation chamber comprising a nano orifice where, by a phenomenon of hydro cavitation, collapsing nano liquid molecules to generate instantaneous temperatures of approximately 1,000 degrees centigrade resulting in quick reaction taking place at the surface of collapsing nano molecules to continue the reaction of the feed oil, acid catalyst, and solvent mixture;
cycling the partially reacted feed oil, acid catalyst, and solvent mixture through the cavitation chamber more than one time to continue the reaction to produce raw biodiesel; and
distilling the raw biodiesel to produce finished biodiesel.
